(19) United States
(12) Patent Application Publication
(10) Pub. No.: US 2006/0280870 A1
(43) Pub. Date: Dec. 14, 2006

(54) Article with droplet-like coating and method for making same

(76) Inventors: Bruno Halot, Sennecey le Grand (FR); Pierre Mermoud, Frangy (FR)

Correspondence Address: HOWREY LLP, C/O IP DOCKETING DEPARTMENT, 2941 FAIRVIEW PARK DR., SUITE 200, FALLS CHURCH, VA, 22042, US

(21) Appl. No.: 10/484,256

(22) PCT Filed: Jul. 17, 2002
(86) PCT No.: PCT/FR02/02530

§ 371 Date: Jan. 20, 2004

(30) Foreign Application Priority Data
Jul. 20, 2001 (FR) 0109722

(51) Int. Cl. B05D 5/00; B41M 5/00

(52) U.S. Cl. 427/258; 428/195.1

(57) ABSTRACT

The invention concerns a method for making adherent relief coating surface simulating the appearance of liquid droplets, comprising direct transfer application (and preferably by screen-printing) of a curable liquid material on the surface so as to form on the surface projecting discrete drops which are then cured: Drops of different sizes are applied, preferably in ordered manner.

The present invention relates to an article with a coating with simulates droplets of liquid.

Such articles are known, in particular in the field of cosmetics cases (and in particular for lids for lipstick or the like). According to document GB 855 152, a liquid composition which contains bubbles of resin in a binder, the bubbles forming by expansion on curing, is applied onto an article. The appearance obtained does not really look like droplets deposited onto the surface of the object, but instead more like bubbles trapped in the coating. In order to obtain an appearance of surface droplets, looking somewhat like the condensation which can form on a surface, document U.S. Pat. No. 5,324,546 discloses spraying droplets of resin onto the surface of the article and crosslinking the resin. However, the resultant appearance is difficult to predict and to reproduce from one article to another.

It is an object of the invention to propose an article and a method for making same which comprises a reproducible coating in the form of high-relief droplets, and in which it is possible to control the size of the droplets so as, for example, to select a precise distribution of small or large droplets and to obtain highly characteristic visual effects.

The object of the invention has been achieved thanks to a method for making on a surface of an article an adherent relief coating which simulates the appearance of liquid droplets, said method comprising application of a curable liquid material onto the surface so as to form on the surface projecting discrete drops which are then cured, wherein application is performed by direct transfer. Direct transfer is intended to mean application of the transfer printing type: the liquid material is initially contained in various reservoirs provided in a printing support in accordance with a determined pattern which will be reproduced in reverse on the surface of the article; the support is offered up to the surface to be printed (or vice versa) and the liquid material passes directly from the reservoirs onto the surface. The printing support may be a rubber matrix of honeycomb cells or a metallic printing plate, but application is preferably performed by screen printing. The techniques of screen printing are well known per se and will not be described here. The use of screen printing for producing decoration on cosmetic articles is also described in document EP 0 860 300. The screen printing screen is adjusted to the desired effect: on the one hand, a mesh size which allows the material being deposited to pass through rapidly is preferably selected; on the other hand, the thickness of the photopolymer which, on exposure to light, will form the printed pattern is sufficient to form a reservoir of material capable of forming drops.

Advantageously, a surface is matched with a liquid material which exhibits therewith a difference in surface tension which results in a low level of wetting. In other words, the surface tension of the product being applied to yield the drops is such that, depending on the surface tension of the surface of the article, a true drop is formed, of the type of a slightly flattened sphere (it forms an undercut angle with the surface onto which it is applied), and the product does not spread out on the surface. The surface of the article (of metal or plastics) is generally coated with a lacquer prior to application of the droplets. The person skilled in the art knows how to modify and control the surface tension of the lacquer and/or resin by adding silicones, for example, in order to obtain a satisfactory relationship. It is more preferred to reduce the surface tension of the substrate lacquer by adding silicones in order to obtain a difference in surface tensions between said lacquer and the product applied of approximately 30%.

Advantageously, drops of different sizes are applied onto the surface, and still more advantageously, they are applied in an ordered manner, for example so as to increase in size from the bottom to the top of an article, such as a cap, and more or less aligned vertically, so as to simulate the bubbles which form in a glass of champagne.

After deposition, the material of the droplets is cured by polymerization in air or under the action of heat or ultraviolet radiation. The droplets form a high relief on the surface of the article.

The material of the droplets is advantageously an adhesive or a lacquer. The droplets may be colored or colorless (crystal clear).

1. A method for making on a surface of an article an adherent relief coating which simulates the appearance of liquid droplets, said method comprising application of a curable liquid material onto the surface so as to form on the surface projecting discrete drops which are then cured, wherein application is performed by direct transfer.

2. The method as claimed in claim 1, wherein the application is performed by screen printing.

3. The method as claimed in claim 1 wherein the surface and the liquid material exhibits a difference in surface tension which results in a low level of wetting.

4. The method as claimed in claim 1, wherein drops of different sizes are applied onto the surface.

5. The method as claimed in claim 4, wherein the drops of different sizes are applied in an ordered manner.

6. An article comprising an adherent relief coating simulating the appearance of liquid droplets, resulting from the application of a curable liquid material onto the surface so as to form on the surface projecting discrete drops which are then cured, wherein application has been performed by direct transfer as claimed in any one of claims 1 to 5.

7. The method as claimed in claim 2, wherein the surface and the liquid material exhibit a difference in surface tension which results in a low level of wetting.

8. The method as claimed in claim 7, wherein drops of different sizes are applied onto the surface.

9. The method as claimed in claim 8, wherein the drops of different sizes are applied in an ordered manner.
